(19) United States
(12) Patent Application Publication
(10) Pub. No.: US 2022/0184933 A1
(43) Pub. Date: Jun. 16, 2022

(54) BIODEGRADABLE LAMINATED COMPOSITE MATERIAL AND METHOD OF USE

(71) Applicant: NAVA DIMERMANAS, Boulogne Billancourt (FR)

(72) Inventor: NAVA DIMERMANAS, Boulogne Billancourt (FR)

(21) Appl. No.: 17/551,425

(22) Filed: Dec. 15, 2021

Related U.S. Application Data
(60) Provisional application No. 63/125,867, filed on Dec. 15, 2020.

(51) Int. Cl. B32B 27/18; B32B 7/12; B32B 27/10

(52) U.S. Cl. CPC B32B 27/18; B32B 7/12; B32B 27/10; C08K 11/00; B32B 2250/03; B32B 2307/7163; B32B 2264/06; B32B 2250/02

(57) ABSTRACT

A laminated composite material includes a plastic layer, an adhesive layer, and a permeable layer. The adhesive layer includes an additive applied to a surface of the plastic layer. The additive is configured to initiate the biodegrading of the plastic material. The permeable layer is configured to cover a portion of the adhesive layer to selectively regulate exposure of the adhesive layer to moisture which acts to initiate the additive.

### CROSS REFERENCE TO RELATED APPLICATIONS

This application claims the benefit of an earlier filing date and right of priority to U.S. Provisional Application No. 63/125,867, filed 15 Dec. 2020, the contents of which is incorporated by reference herein in its entirety.

### BACKGROUND OF THE INVENTION

### 1. Field of the Invention

The present application relates to paper products, and more particularly to biodegradable papers.

### 2. Description of Related Art

Paper, particularly wrapping paper used for wrapping gifts, can commonly include plastics, glitters, and/or foils, which are used for decorative or preservative purposes. Wrapping paper wraps a gift to temporarily conceal the gift until opened by a gift recipient. Typically the recipient tears open the paper to reveal the gift, thus making the paper unusuable for future use in its damaged form and is therefore discarded as trash. This presents an environmental concern as the use of temporary single-use papers, such as wrapping paper, generally include plastics, glitters, and/or foils that make the paper impossible to recycle, thus adding to landfills additional waste that cannot be broken down and be reused again.

There are many existing recycling processes that can rapidly biodegrade plastics via enzymatic digestion. These are highly controlled, large-scale processes that are available to process plastic materials that are properly collected and transported to such facilities. However, not all plastic products are properly collected and sent to recycling facilities. It is common to see some landfilled or littered. This pollutes the environment and does not biodegrade in any reasonable time frame. Another problem awaiting a solution is the presence in the waste stream of composite materials (such as plastic/paper laminates) that are not readily processable even in dedicated facilities when properly disposed of. This illustrates the extreme difficulty of how to actually discard composite plastic products whether properly collected or not.

One approach has been to embed enzymes directly into plastic so that it has the necessary components within itself to accelerate biodegradation should the plastic not be properly recycled. There are some positives with this approach including: 1) having the enzyme directly embedded into the plastics ensures that the enzymes are in good contact with the plastic; and 2) it is good for thicker plastics where the enzyme would be globally available as the plastic degrades over time.

Even this approach, however, has disadvantages that cannot be overlooked. Most plastic products require a thermal step to form the plastic, which can harm the enzyme and also limit the types of enzymes that could be used. Therefore, the enzymes have to be temperature resistant enzymes, meaning not all enzymes are therefore available for consideration merely because of manufacturing steps of the plastic. This prevents viable alternatives from being considered.

Additionally, specialized manufacturing techniques to make these embedded plastics could be expensive and cost prohibitive. Likewise, enzymes need to be nano-sized to not affect the plastic properties and also make sure the enzyme is available throughout the plastic. Making nanoparticle enzymes is a science of itself and is most likely a difficult and cost prohibitive additional step.

Despites such advances in this area of technology, considerable shortcomings remain. It is therefore desired to make a biodegradable laminated plastic packaging with rapid biodegradation by using a layered coating.

### BRIEF SUMMARY OF THE INVENTION

It is an object of the present application to provide a biodegradable fiber composite material which is dissolvable in water and can withstand some degree of moisture. An exemplary intent of such invention is to replace conventional wrapping paper that struggles to biodegrade over time or to be recycled due to the content of the paper. In one embodiment, the coating over the paper includes a non-biodegradable polymer is used to assist the degradation of the coating overall.

Another object of the invention is to include the steps of creating a layered coating for laminated plastic packaging and wrapping film that self-initiates (upon contact with water) the accelerated, rapid biodegradation of the plastic components. One or more layered coatings may be used and the properties of the one or more layers may be adjusted to facilitate selected performance criteria, for example, criteria related to degradation rates.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side section view of a laminated composite material in accordance with an embodiment of the present application.

FIG. 2 is a cross-section of a paper assembly, in accordance with an embodiment of the present application.

FIG. 3 is a chart of substances potentially usable with a coating of the paper assembly of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

Embodiments of the present invention overcome one or more of the above-discussed problems commonly associated with biodegradable paper. In particular, the assembly of the present invention is a paper composite capable of withstanding some degree of moisture comprising a dissolvable biodegradable fiber composite material that is configured to dissolve in water and a coating that coats the biodegradable fiber that is configured to degrade over time in the presence of water. The coating may comprise of a biodegradable material, a non-biodegradable material, or a combination thereof.

The assembly will be understood from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments are expressly contemplated herein so that one of ordinary skill in the art would appreciate from this disclosure that the features, elements, and/or functions of one embodiment may be incorporated into another embodiment as appropriate unless otherwise described.

The embodiments and method of the present application is illustrated in the associated drawings. The invention includes utilizing an enzyme or microorganism of some type to assist in the selective degradation of plastic products. It involves the inclusion of a layered coating for laminated plastic packaging to increase the degradation rate. The physical structure of the laminated product can vary and may be described herein along with a method of testing performed. Additional features and functions are illustrated and discussed below.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

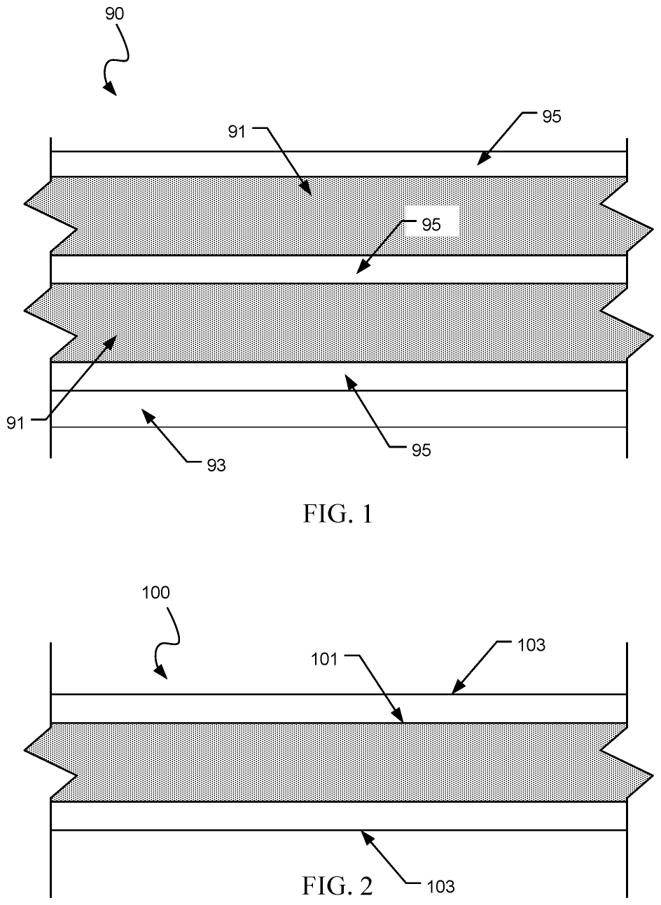

Instead of embedding enzymes directly into a plastic as noted with some of the disadvantages of the prior art, the present application proposes to have enzymes available to the plastic via a thin layered coating. The enzymes are a self contained auto initiated accelerator used to initiate the biodegradation of the plastic. The additive is added to the adhesive. Referring now to FIG. 1 in the drawings, a side section view of a laminated composite material 90 is provided. Material 90 includes a plastic layer 91, an adhesive layer 95, and a permeable layer 93. It is understood that material 90 as depicted is for illustration purposes and serves to provide an exemplary layering only. The layering may be adjusted as described herein.

Adhesive layer 95 is located between a plastic layer 91 and a permeable layer 93. Multiple alternating layers are possible as well. This is seen on the upper portion of material 90 wherein adhesive layer 95 is located between plastic layers 91. Additionally, adhesive layer may be an outer layer in some embodiments as shown at the upper portion of material 90. A key point is that the adhesive layer 95 is adjacent to the plastic layer 91 that is to be biodegraded upon water contact. Likewise permeable layer 93 may act as a temporary barrier to retard moisture interaction with adhesive layer 95. Permeable layer 93 may be any material which allows for the transmission of moisture through to its opposing surface, as paper or perforated plastic. It is known that even a mesh may be used in some situations. In a multi-layer embodiment, biodegration would proceed sequentially as each of the plastic layers becomes degraded.

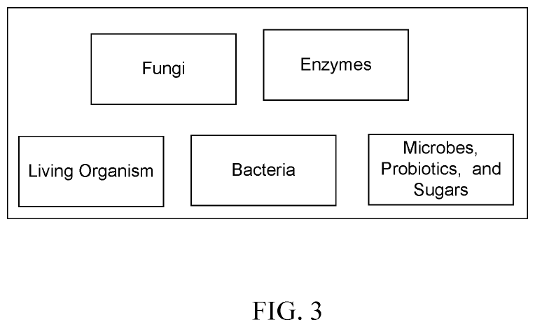

Adhesive layer 95 includes the additive which may include one or more elements or organisms to facilitate the degradation of plastic layer 91. See FIG. 3 and the description below for exemplary additives that may be used to accelerate degradation of the plastic layer.

It is recognized that material 90 is adaptable to current production methods for laminated plastic films and easy to adopt for the converting industry. Thermal requirements for adding enzymes to the plastics are eliminated. This also allows a much broader range of enzymes/additives and adhesives that could be used. Hot melt adhesives could be considered as one of the embodiments. Hot melts are lower melting than the thermoplastics that comprise plastic films, which allows for a wider range of enzymes to be utilized compared with the higher temperatures required for direct incorporation of enzymes into plastic films.

Furthermore, a large array of applications are possible. For example, there are possibilities for materials having multiple layers and layer options as described above. The permeable layer could be either paper or a perforated plastic layer such that it would allow water infiltration and activation of enzymatic action in a delayed manner or it may be unused in relation to one or more adhesive layers and biodegradation would be not delayed with moisture. A wire mesh may also be used in selected situations. The rate of biodegradation depends on the amount of moisture (i.e. water) exposed to the additive. Moisture is prevalent in the environment and is naturally occurring so it is the obvious choice to serve as a catalyst to initiate the process.

A key advantage is that use of the additive in the adhesive layer locates the biodegradation catalyst in an external layer that doesn't require high thermal processing temperatures and enables the possibility of using microorganisms instead of enzymes, which may not be possible when embedding the catalyst directly into the plastic. Microorganisms are ideally suited for application in the adhesive layer and may provide additional benefits not seen through merely enzymes.

Despite the many advantages, material 90 sees the best performance wherein plastic material 91 is relatively thin having a large surface area relative to volume. The precise relationships can depend on any number of factors and have an impact on performance.

For example, upon testing of different suitable enzymes and performance characteristics, key features were realized. The following is a description of the conditions and steps for preparing the paper/polylactic acid laminates with enzyme-containing adhesive. A simple experiment was performed using an adhesive with different enzymes: Proteinase K, Lipase, alpha-Chymotryppsin, and Esterase. Strips of a plastic material were incubated in a phosphate buffer solution with each enzyme at two concentrations at a selected temperature and with gentle agitation. Weights were compared before and after to measure the amount of degradation of the plastic material.

Various polymer materials (additives) were tested for inclusion in the adhesive layer such as: Polyvinyl pyrrolidone (PVP) 55,000 MW, Polyvinyl pyrrolidone 360,000 MW, Polyvinyl alcohol (PVA) 18,000 MW, Polyvinyl alcohol 150,000 MW, Na Carboxymethyl cellulose (CMC) 250,000 MW, and Glycerol. These are exemplary and are not intended to limit the types of adhesive materials used in material 90.

Materials used to conduct the testing were as follows:
1. Polylactic acid (PLA) film: (Goodfellow 502-330-14), 0.05 mm×150 mm×150 mm biaxially oriented, transparent.
2. Paper: 30 lb kraft paper (Uline S-3573)
3. Adhesive polymer: Polyvinyl pyrrolidone (PVP) MW 360,000 kD (Sigma)
4. Enzyme: Proteinase K from Tritirachium album, lyophilized powder (Sigma P6556)
5. Sodium phosphate, monobasic monohydrate, 98+% (Fisher Scientific)
6. Sodium hydrogen phosphate, anhydrous, ACS, 99.0% (Fisher Scientific)
7. Deionized (DI) water

Procedurally, a 0.1 M Phosphate buffer was prepared by dissolving quantities of sodium hydrogen phosphate anhydrous and quantities of sodium phosphate monobasic monohydrate in sufficient DI water for a final volume of 500 mL. Final pH adjustment was made as necessary with dilute phosphoric acid. A 20 wt % PVP was prepared by combining PVP and the phosphate buffer with heating to 50-60° C. to dissolve. The mixture was then allowed to cool to ambient temperature resulting in a clear viscous fluid.

Enzyme-containing adhesive was prepared with various enzymes. Laminates were prepared by gluing approximately 2 in×2 in squares of paper and PLA film together using the above enzyme-containing adhesive. Adhesive was spread on the PLA film at ambient temperature, the paper was placed on top, and the laminate was pressed together with a roller to bring the paper and PLA into close contact and squeeze out any excess glue. The laminate was laid flat and allowed to air dry at ambient temperature for approximately 48 hrs. The PLA and paper were securely bonded together after drying. This formed a layering as follows: an adhesive layer laid over a paper layer wherein the PLA layer was laid over the adhesive layer. The laminate samples were then exposed to a small amount of water and held wet at a temperature of 35° C. without agitation.

The enzymes of Proteinase K appeared to perform the best of the samples. The rate of biodegrading of the plastic material was 100 times faster with use of the additive of Proteinase K. This is not to say other enzymes were not effective or would not be more effective in other situations.

Referring now to FIG. 2, a cross-section of paper assembly 100 is illustrated in accordance with an embodiment of the present invention. The embodiment of FIG. 2 serves as a realistic application of material 90 and the principles above. In FIG. 2, a paper assembly 100 includes, but is not limited to, fiber composite 101 and coating 103. In general, fiber composite 101 is a planar body wherein coating 103 encapsulates the planar body. In other words, coating 103 coats at least one planar face of fiber composite 101.

Fiber composite 101 is ideally comprised of organic fibers. For example, fiber composite 101 is a material that may include the materials selected from the group consisting of cellulose, cellulose derivatives (e.g., sodium methyl cellulose), wool, or combinations thereof. Optionally, fiber composite 101 may also include one or more additives, such as adhesives or waxes. Optionally, fiber composite 101 comprises paper, such as rolled paper products or poster board.

Coating 103 is a coating material that is configured to degrade over time in the presence of water. Coating 103 can be a biodegradable material, a non-biodegradable material, or a combination thereof.

Biodegradable materials for coating 103 include, but is not limited to, materials selected from a group consisting of polymers, lignin, polyurethane modified with poly(lactic-co-glycolic acid) (PLGA), starch acetate, a poly(lactic acid), a poly (butylene succinate), a cellulose triacetate, a poly(caprolactone), a poly(butylene terephthalate adipate), a cellulose acetate, or a combination thereof. These materials may be mixed into the solution forming coating 103 or may be applied post application onto a surface of coating 103.

Paper assembly 100 may be used with non-biodegradable materials as well. Non-biodegradable materials for coating 103 comprises a non-biodegradable polymer such as an enzyme or an additive that is configured to assist in degrading the coating. The enzyme can be a chemical enzyme such as poly(ethylene terephthalate) hydrolase (PETase), PETase mutant.

Referring now also to FIG. 3 in the drawings, a chart of additional substances for use with coating 103 are illustrated. Optionally, coating 103 may further comprise one or more types of substances, or celled organisms that produce enzymes for degrading the coating. Celled organisms include, but is not limited to, fungi, bacterias, or yeasts (e.g., Pseudozyma). An example of fungi may be Pestalotiopsis microspore, Mycelium from mushrooms such as Pleurotus ostreatus and Schizophyllum commune, Aspergillus tubingensis, or any other fungi known in the art that have been found to decompose plastics. Additionally, an example of bacterias may be Ideonella sakaiensis, bacterial genus Pseudomonas, bacterial genus Sphingomonas. Coating 103 may further comprise other microbes, probiotics, sugars, and/or modified sugars.

It is understood that the substances or properties of coating 103 may be adjusted or modified to facilitate differing rates of degradation. Coating 103 may be combined with a solution to assist in the biodegrading of the paper. Furthermore, the time at which the paper begins to degrade may be held in abeyance, as in a time release function, wherein the substances to assist in biodegrading the paper is active only upon a set parameter, such as moisture level, time and moisture level, and so forth. Other features are contemplated herein and the disclosure is not meant to be limiting.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A laminated composite material, comprising:
a plastic material;
an adhesive layer in contact with a first surface of the plastic material; and
a permeable layer in contact with an opposing surface of the adhesive layer as that of the plastic material, the permeable material configured to allow for the transfer of moisture;
wherein the adhesive layer includes an additive to biodegrade the plastic material, the additive being included separate from the plastic material.

2. The material of claim 1, wherein the permeable layer is paper

3. The material of claim 1, wherein the permeable layer is a perforated plastic.

4. The material of claim 1, wherein the additive is at least one of Proteinase K, Lipase, alpha-Chymotryppsin, and Esterase.

5. The material of claim 1, wherein the additive is activated with moisture.

6. The material of claim 1, further comprising:
a second adhesive layer on a second surface of the plastic material.

7. The material of claim 1, wherein the additive is a fungi.

8. The material of claim 1, wherein the additive is a living organism.

9. The material of claim 1, wherein the additive is a bacteria.

10. The material of claim 1, wherein the additive is at least one of a microbe, probiotic, and sugar.
